(19) United States
(12) Patent Application Publication
(10) Pub. No.: US 2026/0030770 A1
(43) Pub. Date: Jan. 29, 2026

(54) METHOD FOR DETECTING DOOR GAP OF VEHICLE BODY BASED ON EDGE DETECTION

(71) Applicant: Nanjing SFJ Software Technology Co. Ltd., Nanjing (CN)

(72) Inventors: Xiaojia LU, Nanjing (CN); Minhao ZHOU, Nanjing (CN); Ru YU, Nanjing (CN)

(21) Appl. No.: 18/993,969

(22) PCT Filed: Dec. 22, 2022
(86) PCT No.: PCT/CN2022/141041

§ 371 Date: Jan. 13, 2025

(30) Foreign Application Priority Data
Jul. 14, 2022 (CN) 202210825110.6

(51) Int. Cl. G06T 7/60; G06V 10/28; G06V 10/34; G06V 10/44

(52) U.S. Cl. CPC G06T 7/60; G06V 10/28; G06V 10/34; G06V 10/443

(57) ABSTRACT

This application provides a method for detecting a door gap of a vehicle body based on edge detection, including: detecting a vehicle body door gap image; performing image filtering; smoothing a filtered image, and calculating gradients and directions of the image to form a gradient image; performing non-maximum suppression on gradient magnitudes, and only retaining local maxima to obtain discrete points of a gradient edge contour image; giving a low threshold and a high threshold, marking points with gradient values greater than the high threshold as strong edge pixels, and anchor points in the image, and connecting the anchor points to form an edge image; and extracting a feature point of the edge image, matching the feature point with a laser-marked image window, finding a position perpendicular to the door gap, and calculating a Manhattan distance at the window to obtain a minimum for a width of the door gap.

### CROSS REFERENCE TO RELATED APPLICATION

The present application is a national stage application of International Patent Application No. PCT/CN2022/141041, filed on Dec. 22, 2022, which claims priority to the Chinese Patent Application No. 202210825110.6, filed with the China National Intellectual Property Administration (CNIPA) on Jul. 14, 2022, and entitled “METHOD FOR DETECTING DOOR GAP OF VEHICLE BODY BASED ON EDGE DETECTION,” which is incorporated herein by reference in its entirety.

### TECHNICAL FIELD

The present disclosure relates to the field of vehicle door detection, and in particular to a method for detecting a door gap of a vehicle body based on edge detection.

### BACKGROUND

The vehicle body is one of the most basic components of the vehicle and can be referred to as the basic skeleton of the vehicle. Almost all the components on the vehicle are mounted on the vehicle body. Performance of the whole vehicle depends on quality of the vehicle body to some extent. The vehicle body is a complex shell structure to which a large quantity of stamped parts or metal components are welded, riveted and mechanically connected. Since the welding is more superior to other methods, the vehicle body is connected mainly by the welding.

The door is one of the important components of the whole vehicle body. After the door is closed, the size and the degree of misalignment of the gap are two crucial indicators to ensure normal closure of the door, and normal safe operation of the vehicle. In case of a deviation of the two indicators, the door is closed undesirably, resulting in poor soundproof effect, poor waterproof effect, and problems with the personal safety and the like. Hence, convenient, quick and accurate detection on whether the width of the door gap is qualified becomes a vital part in vehicle production. In view of this, the present disclosure provides a method for detecting a door gap of a vehicle body based on edge detection. The present disclosure designs a machine vision detection system for the door gap of the vehicle body, quickly acquires image data of the door gap, and quantitatively detects the width of the door gap through the edge detection.

### SUMMARY

To solve the above problem, the present disclosure provides a method for detecting a door gap of a vehicle body based on edge detection, specifically including the following steps:
step 1: building a vehicle body door gap detection device, and detecting a vehicle body door gap image, the detection device including a light controller, a charge coupled device (CCD) camera, a laser line emitter, a communication network, and a computer processing system;
step 2: performing image filtering, specifically: graying a detected vehicle body door gap image, and filtering a grayed image;
step 3: smoothing a filtered image with a first-order partial derivative of a Gaussian function, calculating gradients and directions of the image with a finite difference of the first-order partial derivative to form a gradient image, and taking a Roberts operator as an edge detection operator;
step 4: performing non-maximum suppression (NMS) on gradient magnitudes in the gradient image, and only retaining local maxima to obtain discrete points of a gradient edge contour image;
step 5: giving a low threshold and a high threshold, marking points with gradient values greater than the high threshold as strong edge pixels, and as anchor points in the image, and setting a pixel for a point with a gradient value less than the low threshold as 0, and connecting the anchor points to form an edge image; and
step 6: extracting a feature point of the edge image, matching the feature point with a laser-marked image window, finding a position perpendicular to the door gap, calculating a Manhattan distance at the window, taking a maximum Manhattan distance in the window as a Manhattan width for the door gap of the vehicle body, determining a width of the door gap of the vehicle body, and obtaining a minimum for the width of the door gap according to the width of the door gap in multiple frames of images.

Further, a process of building the vehicle body door gap detection device in the step 1 is as follows:
providing the CCD camera directly in front of a door of a to-be-detected vehicle, irradiating the door gap perpendicularly with a strip laser line emitted by the laser pointer, and rotating the camera by a certain angle around a beam at a to-be-detected position, where on an image photographed by the camera, the laser line forms a breakpoint in the door gap; and further moving the camera along a forming direction of the door gap to acquire multiple frames of vehicle body door gap images, and uploading image data to the computer processing system through the communication network.

Further, a process of performing image filtering in the step 2 is as follows:
step 2.1: respectively taking gray images of two continuous frames of images as an input image and a guided image, and acquiring a filtered output image by:

$${O}_{i} = {a}_{k} {G}_{i} + {b}_{k} , i ∈ {ω}_{k} \qquad ( 1 )$$

where, O is an output image, G is the guided image, Oᵢ is the output image through a filtering window, Gᵢ is a guided image through the filtering window, aₖ and bₖ are a filter coefficient, ωₖ is the filtering window, and k is an image position;
step 2.2: defining a cost function for the image filtering:

$$min {\sum }_{i ∈ {ω}_{k}} ( {a}_{k} {G}_{i} + {b}_{k} - {I}_{i} + ε {a}_{k}^{2} ) \qquad ( 2 )$$

where, I is the input image, Iᵢ is an input image through the filtering window, and ε is a regularization parameter;
step 2.3: seeking a partial derivative of each of the aₖ and the bₖ, and setting the partial derivative as zero to obtain:

$${b}_{k} = {mean ( I )}^{{ω}_{k}} - {a}_{k} {mean ( G )}^{{ω}_{k}} \qquad ( 3 )$$

$${a}_{κ} = \frac{Cov ( G , I )}{Var ( G ) + ε} \qquad ( 4 )$$

where, mean is a mean operation, Cov is a covariance formula, and Var is a variance formula; and
step 2.4: after the aₖ and the bₖ are determined, filtering the input image by the equation (1) to obtain the filtered image.

Further, the gradient image is formed as follows in the step 3:
converting the filtered image into the gradient image by:

$${g}_{x} = f ( x + 1 , y + 1 ) - f ( x , y ) \qquad ( 5 )$$

$${g}_{y} = f ( x + 1 , y ) - f ( x , y + 1 ) \qquad ( 6 )$$

where, gₓ is a gradient value in an x-axis direction, g_{y} is a gradient value in a y-axis direction, an x-axis represents a horizontal direction, a y-axis represents a vertical direction, and f(x,y) is a gray value at a position (x,y) in the filtered grayed image.

Further, the edge image is formed as follows in the step 5:
step 5.1: calculating a Manhattan distance between the anchor points by:

$$d = \vert {x}_{1} - {x}_{2} \vert + \vert {y}_{1} - {y}_{2} \vert \qquad ( 7 )$$

where, d is a distance between the anchor point (x₁, y₁) and the anchor point (x₂, y₂), x₁ and x₂ each are a horizontal coordinate of the anchor point, and y₁ and y₂ each are a vertical coordinate of the anchor point; and
step 5.2: selecting the anchor point at minimum Manhattan distances with surrounding anchor points, decomposing the anchor point in different directions to obtain data of different analysis requirements, selecting another anchor point at a minimum Manhattan distance with the anchor point, and connecting the two anchor points to obtain the edge image.

Further, the minimum for the width of the door gap is obtained as follows in the step 6:
step 6.1: extracting the feature point L_{Hessian} of the edge image by:

$${L}_{Hessian} = {σ}^{2} ( {L}_{xx} {L}_{yy} - {L}_{xy}^{2} ) \qquad ( 8 )$$

where, σ is a scale parameter of the present image, Lₓₓ and L_{yy} are respectively a second-order differential of the image at a position x and a second-order differential of the image at a position y, and L_{xy} is a second-order cross partial derivative;
step 6.2: determining whether two feature points are matched by calculating an Euclidean distance between eigenvectors, and in combination with a ratio of a distance of a nearest neighbor to a distance of a second nearest neighbor, comparing the ratio with a preset threshold, and taking the point with the ratio less than the preset threshold as a laser-marked point;
step 6.3: photographing, by the camera, a standard calibration board with a distance sensor, and calculating a corresponding size of each pixel through the equation (7), where a distance between the camera and the standard calibration board and the corresponding size of the pixel form a set of data;
step 6.4: measuring different distances of the camera from the standard calibration board, and calculating a corresponding size of each pixel of the camera at the different distances;
step 6.5: calculating an angle of divergence of the camera through data in the step 6.4, where when a physical object is measured, a distance from the camera to a reference laser line on a surface of the measured object is the same;
step 6.6: if the distance in the step 6.5 is different, through the angle and the distance in the step 6.5, calculating a size of each pixel at the distance, where the size is multiplied with a number of pixels in a Manhattan method to obtain a length of the gap at the distance; and
step 6.7: decomposing a minimum measured distance in different directions to obtain different desired size data.

The method for detecting a door gap of a vehicle body based on edge detection provided by the present disclosure has the following beneficial effects:

1. The method for detecting a door gap of a vehicle body based on edge detection provided by the present disclosure realizes automatic detection on the width of the door gap of the vehicle body.

2. With the quick and non-approximate linear-time algorithm in the filtering, the present disclosure can effectively defog and feather the image.

3. With the Manhattan distance for selecting the anchor points in the edge detection, the present disclosure can effectively reduce the over-segmentation and the false segmentation.

4. By matching the feature point of the edge image with the laser-marked point, the present disclosure can quickly localize the door gap of the vehicle body.

5. The present disclosure is also applied to measure the physical object, which can be taken as an inverse method for clearance measurement.

### BRIEF DESCRIPTION OF THE DRAWINGS

FIG. 1 is a flowchart according to the present disclosure;

FIG. 2 is a flowchart of edge detection according to the present disclosure;

FIG. 3 illustrates a photography method according to the present disclosure;

FIG. 4 illustrates a standard calibration board according to the present disclosure; and

FIG. 5 illustrates a schematic diagram according to the present disclosure.

### DETAILED DESCRIPTION OF THE EMBODIMENTS

The present disclosure is further described below in detail in combination with accompanying drawings and specific implementations.

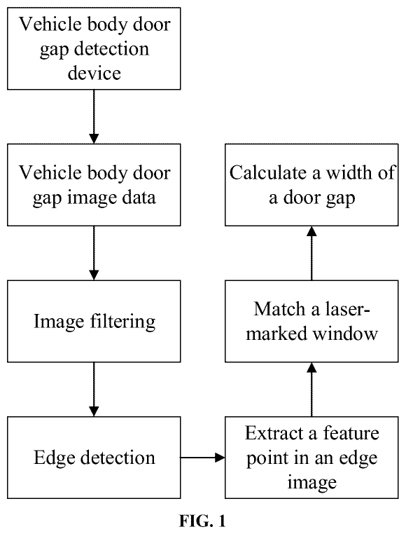

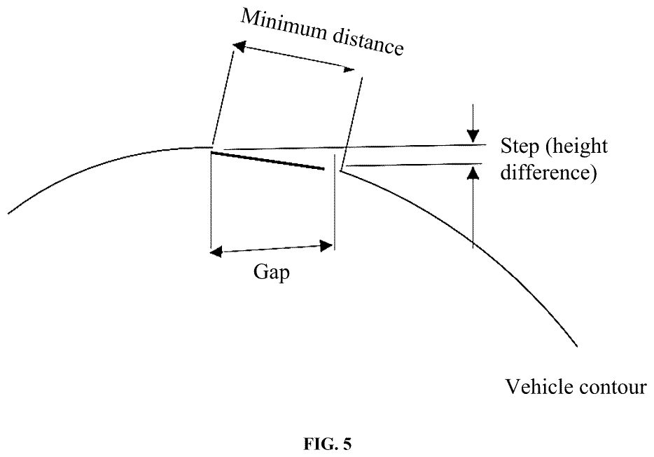

The present disclosure provides a method for detecting a door gap of a vehicle body based on edge detection. With image data acquired by a CCD camera, and in combination with steps such as image filtering, edge detection, and feature point matching, the present disclosure realizes detection on the width of the door gap of the vehicle body. Through the image filtering, the present disclosure can effectively defog and feather the image. With the Manhattan distance for selecting the anchor points in the edge detection, the present disclosure can effectively reduce the over-segmentation and the false segmentation. FIG. 1 illustrates a schematic structural view according to the present disclosure. FIG. 5 illustrates a schematic diagram according to the present disclosure. In combination with the schematic structural view, namely FIG. 1 and FIG. 5, the present disclosure is described below in detail.

Step 1: A vehicle body door gap detection device is built, and a vehicle body door gap image (vehicle body door gap image data) is detected. The detection device includes a light controller, a CCD camera, a laser line emitter, a communication network, and a computer processing system, etc.

The CCD camera is provided directly in front of a door of a to-be-detected vehicle. The door gap is irradiated perpendicularly with the laser line emitter. A laser line forms a breakpoint in the door gap. The camera is further moved along a forming direction of the door gap to acquire multiple frames of vehicle body door gap images. Image data is uploaded to the computer processing system through the communication network.

Step 2: Image filtering is performed. Specifically, a detected vehicle body door gap image is grayed, and a grayed image is filtered.

Step 2.1: Gray images of two continuous frames of images are respectively taken as an input image and a guided image, and a filtered output image is acquired by:

$${O}_{i} = {a}_{k} {G}_{i} + {b}_{k} , i ∈ {ω}_{k} \qquad ( 1 )$$

In the foregoing equation, O is an output image, G is the guided image, Oᵢ is the output image through a filtering window, Gᵢ is a guided image through the filtering window, aₖ and bₖ are a filter coefficient, ωₖ is the filtering window, and k is an image position.

Step 2.2: A cost function for the image filtering is defined:

$$min {\sum }_{i ∈ {ω}_{k}} ( {a}_{k} {G}_{i} + {b}_{k} - {I}_{i} + ε {a}_{k}^{2} ) \qquad ( 2 )$$

In the foregoing equation, I is the input image, Iᵢ is an input image through the filtering window, and ε is a regularization parameter.

Step 2.3: A partial derivative of each of the aₖ and the bₖ is sought, and the partial derivative is set as zero to obtain:

$${b}_{k} = {mean ( I )}^{{ω}_{k}} - {a}_{k} {mean ( G )}^{{ω}_{k}} \qquad ( 3 )$$

$${a}_{κ} = \frac{Cov ( G , I )}{Var ( G ) + ε} \qquad ( 4 )$$

In the foregoing equations, mean is a mean operation, Cov is a covariance formula, and Var is a variance formula.

Step 2.4: After the aₖ and the bₖ are determined, the input image is filtered by Equation (1) to obtain the filtered image.

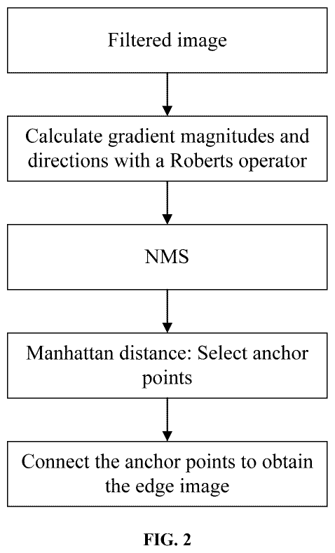

Step 3: The filtered image is smoothed with a first-order partial derivative of a Gaussian function, gradients and directions of the image are calculated with a finite difference of the first-order partial derivative to form a gradient image, and a Roberts operator is taken as an edge detection operator, that is, the edge detection is performed on the filtered image. The edge detection is as shown in FIG. 2. For the filtered image, gradient magnitudes and directions are calculated with the Roberts operator. NMS is performed. Manhattan distances are calculated. Anchor points are selected. The anchor points are connected to obtain an edge image.

The filtered image is converted into the gradient image by:

$${g}_{x} = f ( x + 1 , y + 1 ) - f ( x , y ) \qquad ( 5 )$$

$${g}_{y} = f ( x + 1 , y ) - f ( x , y + 1 ) \qquad ( 6 )$$

In the foregoing equations, gₓ is a gradient value in an x-axis direction, g_{y} is a gradient value in a y-axis direction, an x-axis represents a horizontal direction, a y-axis represents a vertical direction, and f (x,y) is a gray value at a position (x,y) in the filtered grayed image.

Step 4: NMS is performed on gradient magnitudes in the gradient image, and local maxima are only retained to obtain discrete points of a gradient edge contour image.

Step 5: A low threshold and a high threshold are given, points with gradient values greater than the high threshold are marked as strong edge pixels, and as anchor points in the image, and a pixel for a point with a gradient value less than the low threshold are set as 0, and the anchor points are connected to form an edge image.

Step 5.1: A Manhattan distance between the anchor points is calculated by:

$$d = \vert {x}_{1} - {x}_{2} \vert + \vert {y}_{1} - {y}_{2} \vert \qquad ( 7 )$$

In the foregoing equation, d is a distance between the anchor point (x₁, y₁) and the anchor point (x₂, y₂), x₁ and x₂ each are a horizontal coordinate of the anchor point, and y₁ and y₂ each are a vertical coordinate of the anchor point.

Step 5.2: The anchor point at minimum Manhattan distances with surrounding anchor points is selected, the anchor point is decomposed in different directions to obtain data of different analysis requirements, another anchor point at a minimum Manhattan distance with the anchor point is selected, and the two anchor points are connected to obtain the edge image.

Step 6: A feature point of the edge image is extracted, the feature point is matched with a laser-marked image window, a position perpendicular to the door gap is found, a Manhattan distance is calculated at the window, a maximum Manhattan distance in the window is taken as a Manhattan width for the door gap of the vehicle body, a width of the door gap of the vehicle body is determined, and a minimum for the width of the door gap is obtained according to the width of the door gap in the multiple frames of images (the width of the door gap is calculated).

Step 6.1: The feature point L_{Hessian} of the edge image is extracted by:

$${L}_{Hessian} = {σ}^{2} ( {L}_{xx} {L}_{yy} - {L}_{xy}^{2} ) \qquad ( 8 )$$

In the foregoing equation, σ is a scale parameter of the present image, Lₓₓ and L_{yy} are respectively a second-order differential of the image at a position x and a second-order differential of the image at a position y, and L_{xy} is a second-order cross partial derivative.

Step 6.2: Whether two feature points are matched is determined by calculating an Euclidean distance between eigenvectors, and in combination with a ratio of a distance of a nearest neighbor to a distance of a second nearest neighbor, the ratio is compared with a preset threshold, and the point with the ratio less than the preset threshold is taken as a laser marked point.

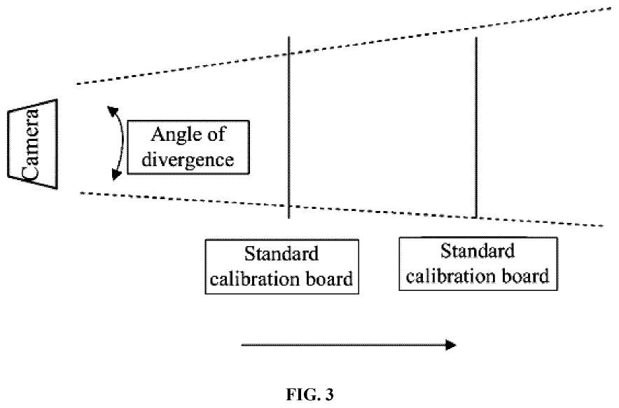

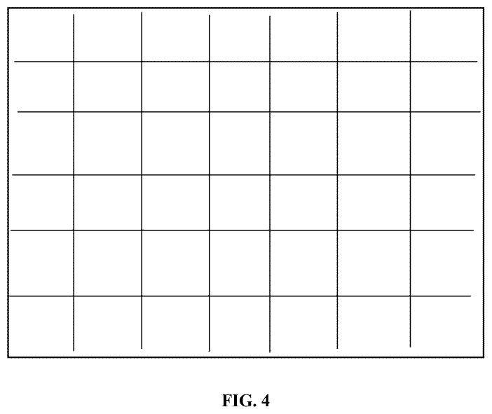

Step 6.3: A standard calibration board is photographed by the camera with a distance sensor, as shown in FIG. 3. The standard calibration board is as shown in FIG. 4. A corresponding size of each pixel is calculated through Equation (7). A distance between the camera and the standard calibration board and the corresponding size of the pixel form a set of data.

Step 6.4: Different distances of the camera from the standard calibration board are measured, and a corresponding size of each pixel of the camera at the different distances is calculated.

Step 6.5: An angle of divergence of the camera is calculated through data in Step 6.4. When a physical object is measured, the distance from the camera to a reference laser line on the surface of the measured object should be same.

Step 6.6: If the distance in Step 6.5 is different. Through the angle and the distance in Step 6.5, the size of each pixel at the distance is calculated. The size is multiplied with a number of pixels in a Manhattan method to obtain a length of the gap at the distance.

Step 6.7: A minimum measured distance is decomposed in different directions to obtain different desired size data.

The above descriptions are only the preferred embodiments of the present disclosure and are not intended to limit the present disclosure in any form. Any modifications or equivalent changes made according to the technical essence of the present disclosure still fall within the protection scope of the present disclosure.

What is claimed is:

1. A method for detecting a door gap of a vehicle body based on edge detection, specifically comprising the following steps:
step 1: building a vehicle body door gap detection device, and detecting a vehicle body door gap image, wherein the detection device comprises a light controller, a charge coupled device (CCD) camera, a laser line emitter, a communication network, and a computer processing system;
step 2: performing image filtering, specifically: first graying a detected vehicle body door gap image, and then filtering a grayed image;
step 3: smoothing a filtered image with a first-order partial derivative of a Gaussian function, calculating gradients and directions of the image with a finite difference of the first-order partial derivative to form a gradient image, and taking a Roberts operator as an edge detection operator;
step 4: performing non-maximum suppression (NMS) on gradient magnitudes in the gradient image, and only retaining local maxima to obtain discrete points of a gradient edge contour image;
step 5: giving a low threshold and a high threshold, marking points with gradient values greater than the high threshold as strong edge pixels, and as anchor points in the image, and setting a pixel for a point with a gradient value less than the low threshold as 0, and connecting the anchor points to form an edge image; and
step 6: extracting a feature point of the edge image, matching the feature point with a laser-marked image window, finding a position perpendicular to the door gap, calculating a Manhattan distance at the window, taking a maximum Manhattan distance in the window as a Manhattan width for the door gap of the vehicle body, determining a width of the door gap of the vehicle body, and obtaining a minimum for the width of the door gap according to the width of the door gap in multiple frames of images.

2. The method for detecting a door gap of a vehicle body based on edge detection according to claim 1, wherein a process of building the vehicle body door gap detection device in the step 1 is as follows:
providing the CCD camera directly in front of a door of a to-be-detected vehicle, irradiating the door gap perpendicularly with the laser line emitter, a laser line forming a breakpoint in the door gap, further moving the camera along a forming direction of the door gap to acquire multiple frames of vehicle body door gap images, and uploading image data to the computer processing system through the communication network.

3. The method for detecting a door gap of a vehicle body based on edge detection according to claim 1, wherein a process of performing image filtering in the step 2 is as follows:
step 2.1: respectively taking gray images of two continuous frames of images as an input image and a guided image, and acquiring a filtered output image by:
$${O}_{i} = {a}_{k} {G}_{i} + {b}_{k} , i ∈ {ω}_{k} \qquad ( 1 )$$
wherein, O is an output image, G is the guided image, Oᵢ is the output image through a filtering window, Gᵢ is a guided image through the filtering window, aₖ and bₖ are a filter coefficient, ωₖ is the filtering window, and k is an image position;
step 2.2: defining a cost function for the image filtering:
$$min {\sum }_{i ∈ {ω}_{k}} ( {a}_{k} {G}_{i} + {b}_{k} - {I}_{i} + ε {a}_{k}^{2} ) \qquad ( 2 )$$
wherein, I is the input image, Iᵢ is an input image through the filtering window, and ε is a regularization parameter;
step 2.3: seeking a partial derivative of each of the aₖ and the bₖ, and setting the partial derivative as zero to obtain:
$${b}_{k} = {mean ( I )}^{{ω}_{k}} - {a}_{k} {mean ( G )}^{{ω}_{k}} \qquad ( 3 )$$
$${a}_{κ} = \frac{Cov ( G , I )}{Var ( G ) + ε} \qquad ( 4 )$$
wherein, mean is a mean operation, Cov is a covariance formula, and Var is a variance formula; and
step 2.4: after the aₖ and the bₖ are determined, filtering the input image by the equation (1) to obtain the filtered image.

4. The method for detecting a door gap of a vehicle body based on edge detection according to claim 1, wherein the edge image is formed as follows in the step 5:
step 5.1: calculating a Manhattan distance between the anchor points by:
$$d = \vert {x}_{1} - {x}_{2} \vert + \vert {y}_{1} - {y}_{2} \vert \qquad ( 7 )$$
wherein, d is a distance between the anchor point (x₁, y₁) and the anchor point (x₂, y₂), x₁ and x₂ each are a horizontal coordinate of the anchor point, and y₁ and y₂ each are a vertical coordinate of the anchor point; and
step 5.2: selecting the anchor point at minimum Manhattan distances with surrounding anchor points, decomposing the anchor point in different directions to obtain data of different analysis requirements, selecting another anchor point at a minimum Manhattan distance with the anchor point, and connecting the two anchor points to obtain the edge image.

5. The method for detecting a door gap of a vehicle body based on edge detection according to claim 1, wherein the minimum for the width of the door gap is obtained as follows in the step 6:
step 6.1: extracting the feature point L_{Hessian} of the edge image by:
$${L}_{Hessian} = {σ}^{2} ( {L}_{xx} {L}_{yy} - {L}_{xy}^{2} ) \qquad ( 8 )$$
wherein, σ is a scale parameter of the present image, Lₓₓ and L_{yy} are respectively a second-order differential of the image at a position x and a second-order differential of the image at a position y, and L_{xy} is a second-order cross partial derivative;
step 6.2: determining whether two feature points are matched by calculating an Euclidean distance between eigenvectors, and in combination with a ratio of a distance of a nearest neighbor to a distance of a second nearest neighbor, comparing the ratio with a preset threshold, and taking the point with the ratio less than the preset threshold as a laser-marked point;
step 6.3: photographing, by the camera, a standard calibration board with a distance sensor, and calculating a corresponding size of each pixel through the equation (7), wherein a distance between the camera and the standard calibration board and the corresponding size of the pixel form a set of data;
step 6.4: measuring different distances of the camera from the standard calibration board, and calculating a corresponding size of each pixel of the camera at the different distances;
step 6.5: calculating an angle of divergence of the camera through data in the step 6.4, wherein when a physical object is measured, a distance from the camera to a reference laser line on a surface of the measured object is the same;
step 6.6: if the distance in the step 6.5 is different, through the angle and the distance in the step 6.5, calculating a size of each pixel at the distance, wherein the size is multiplied with a number of pixels in a Manhattan method to obtain a length of the gap at the distance; and
